(19) United States
(12) Patent Application Publication
(10) Pub. No.: US 2025/0378110 A1
(43) Pub. Date: Dec. 11, 2025

(54) SYSTEM AND METHOD FOR PROVIDING AN INTERACTIVE VIRTUAL TOUR GUIDE

(71) Applicant: The Regents of the University of California, Oakland, CA (US)

(72) Inventor: Andy LiWang, Merced, CA (US)

(21) Appl. No.: 19/233,235

(22) Filed: Jun. 10, 2025

Related U.S. Application Data
(60) Provisional application No. 63/658,635, filed on Jun. 11, 2024.

(51) Int. Cl. G06F 16/387; G06F 16/335; H04W 4/029

(52) U.S. Cl. CPC G06F 16/387; G06F 16/335; H04W 4/029

(57) ABSTRACT

A mobile application is designed to transform the travel experience by integrating artificial intelligence (AI) with global positioning system (GPS) technology to offer a dynamic and interactive tour guide. This mobile application determines a user's geographical location using GPS and responds to natural language queries about the location with synthesized information from various internet sources. The application is capable of maintaining the context of user interactions, allowing for follow-up questions and providing personalized, real-time information based on user preferences and movements. By combining AI capabilities akin to those of conversational platforms like ChatGPT with precise location tracking, the application offers tailored, educative content about surrounding areas, thereby enhancing user knowledge and engagement during travel.

### CROSS-REFERENCE TO RELATED APPLICATIONS

This application claims the benefit of, and priority to, U.S. Provisional Patent Application Ser. No. 63/658,635 filed on Jun. 11, 2024. The entire contents of the foregoing application are incorporated by reference herein.

### TECHNICAL FIELD

The present disclosure relates generally to a software application, e.g., mobile application or website, that provides a customizable, interactive tour guide. More specifically, the disclosure pertains to systems that integrate artificial intelligence (AI), global positioning systems (GPS), and real-time data processing to provide dynamic, interactive travel guides on mobile devices.

### BACKGROUND

Traditional tour guide applications for mobile devices typically rely on pre-recorded audio, video, and/or textual information to guide users through various locations. These applications generally provide a static user experience, where the information delivered is predetermined and unresponsive to real-time user queries. Such systems do not account for the user's specific interests or questions beyond the scope of the pre-programmed content.

Further, while some advancements have been made in integrating interactive elements into travel applications—such as user reviews and real-time updates—these still do not offer a truly interactive experience that caters to on-the-fly, personalized educational content about a region based solely on user input.

Moreover, existing solutions limit their functionality to navigation assistance, providing directions without integrating a deep, context-aware educational layer that can respond to complex inquiries about the surroundings. This represents a significant limitation in the utility of current travel applications, which fail to leverage the full capabilities of AI technologies.

Voice-activated assistants such as Siri and interactive AI chat applications like ChatGPT have begun to revolutionize user interaction by allowing for natural language processing and response generation, these technologies have not been fully integrated with GPS functionalities in a way that provides a cohesive, enriched educational travel experience. Current implementations do not synthesize all available internet information to respond to location-specific queries dynamically, thereby limiting the depth of information accessible on-the-go.

The inability of existing applications to provide dynamic, personalized, and contextually relevant information based on real-time user requests poses a substantial gap in the capabilities of mobile travel guides. As such, there remains a need for an advanced system that overcomes these deficiencies by integrating cutting-edge AI with precise geolocation technologies to deliver a uniquely tailored and responsive user experience.

While current applications may enhance user experience, significant challenges and limitations persist with the current technology offerings. These include a lack of real-time interactivity, personalization, and the full utilization of AI to synthesize and deliver comprehensive, context-specific information. The present disclosure addresses these shortcomings by providing a novel solution that fundamentally transforms how individuals interact with and learn about their surroundings during travel.

### SUMMARY

The present disclosure provides a novel mobile application designed to enhance the travel experience by integrating advanced AI, GPS technology, and real-time internet data synthesis. This application offers a highly interactive, personalized tour guide experience, responding dynamically to user queries with comprehensive and context-specific information about any given location.

In particular, the present disclosure provides for real-time interactive guidance, which enables users to engage with the mobile application in a conversational manner, asking any question about the location they are traversing and receiving accurate, informed responses synthesized from available online data. The mobile application integrates advanced AI with GPS—utilizing cutting-edge AI technologies, similar to capabilities found in platforms like Siri and ChatGPT, combined with precise location tracking via GPS to deliver a seamless and enriched informational experience based on the user's exact location. Further, the mobile application offers personalized content delivery by allowing users to customize their tour experience based on personal interests, including, but not limited to, historical sites, scenic views, or cultural landmarks, by merely instructing the application on their preferences. Additionally, the mobile application enhances educational value of travel by transforming traditional travel experiences. The mobile application provides a platform that offers depth and interaction beyond standard navigational and informational applications currently available.

The system and method of the present disclosure include several innovative features.
AI-powered query response system—the application uses an AI system capable of understanding and processing natural language queries, retrieving relevant information across the internet, and delivering it in a user-friendly manner.
GPS integration—the application utilizes real-time GPS data to determine the user's location and provide geographically relevant information, enhancing the contextuality of responses.
Dynamic content synthesis—unlike static pre-recorded tour apps, the present application dynamically synthesizes content from a multitude of online sources in real-time, ensuring that the information is both current and comprehensive.
Complex query handling—the application is designed to handle a wide range of inquiries from simple factual questions to complex requests requiring synthesis of multiple data points, providing a robust interactive experience.
Customizable tour options—users can customize their tour experience by directing the application to focus on specific types of locations or topics of interest, thereby personalizing the scope of the interaction.

The disclosed system and method represent a significant advancement in the field of mobile travel applications. By harnessing the power of modern AI and GPS technologies, it offers a transformative approach to how individuals interact with and learn about their environments, making it an indispensable tool for travelers seeking a deeply engaging and informative experience. This system redefines the standard for interactive travel guides, fulfilling a critical need in the marketplace and setting a new benchmark for technological innovation in travel.

According to one embodiment of the present disclosure, a mobile application system is disclosed. The mobile application system includes a processor configured to execute software instructions. The system also includes a memory coupled to the processor for storing software instructions. The system also includes a GPS module to determine a geographical location of a user. The system also includes a communication interface for accessing a wide area network. The system also includes an AI module configured to process natural language query received from the user requesting a tour guide pertaining to the geographical location of the user and to synthesize information relevant to the geographical location of the user from multiple internet sources. The system also includes an output module configured to present the synthesized information to the user in an interactive manner.

Implementations of the above embodiment may include one or more of the following features. According to one aspect of the above embodiment, the AI module is further configured to understand and respond to follow-up questions from the user, maintaining context from previous interactions. The AI module includes a large language model. The GPS module provides real-time location tracking to dynamically update the information as the geographical location of the user changes. The output module includes a graphical user interface (GUI) on a mobile device that displays the synthesized information visually along with auditory responses. The system may include a voice recognition module configured to receive the query from the user and to convert these into text for processing by the AI module. The communication interface is configured to retrieve information from at least databases, web pages, and multimedia sources. The system is further configured to allow the user to specify preferences for types of information or topics, which the AI module uses to filter and prioritize the information provided to the user.

Users can specify various preferences for the types of information or topics they are interested in. These preferences include historical sites, where users can receive information about landmarks, monuments, and significant historical locations. They can also choose scenic views, which will provide details about natural scenic locations such as parks, viewpoints, and nature trails. For those interested in cultural landmarks, the system can offer information related to museums, galleries, theaters, and cultural events. Dining options can be customized to provide details about restaurants, cafes, and local cuisine specialties, while shopping preferences can highlight shopping centers, local markets, and specific types of stores.

Additionally, users can specify preferences for accommodation information, including nearby hotels, hostels, and other lodging options. Transportation preferences can provide details on local transportation options such as buses, trains, rental services, and ride-sharing. Local events preferences will keep users informed about current or upcoming events, festivals, and exhibitions in the area. For those interested in outdoor activities, the system can offer information on hiking trails, water sports, and other recreational activities. Educational information preferences can deliver detailed historical, cultural, or scientific explanations about the surroundings.

Moreover, users can specify preferences for nightlife information, including clubs, bars, and nightlife events. Health and safety preferences can highlight the locations of hospitals, clinics, pharmacies, and offer safety tips. Finally, weather updates can be provided, offering real-time weather conditions and forecasts for the current location. These preferences help tailor the information provided by the AI module, ensuring it is relevant and prioritized according to the user's interests.

According to another embodiment of the present disclosure, a method for providing an interactive tour guide using a mobile device is disclosed. The method includes receiving a user input through an input interface of the mobile device. The method also includes processing the user input using an AI module to determine user intent and generate a query related to the user input. The method further includes verifying a user's location using a GPS module of the mobile device. The method additionally includes retrieving data relevant to the query from an internet data retrieval system and synthesizing the retrieved data into a coherent response. The method also includes customizing a tour based on the synthesized data and user preferences and generating and displaying a customized route and response on an output interface of the mobile device.

Implementations of the above embodiment may include one or more of the following features. According to one aspect of the above embodiment, receiving the user input includes capturing voice commands via a microphone, converting the voice commands to text, and processing the text as the user input. The AI module utilizes natural language processing (NLP) to analyze and interpret the user input. The data retrieval includes accessing multiple online sources such as databases, news websites, and specialized content repositories to gather current information relevant to the user's query. Customizing the tour involves selecting points of interest based on the user's location and preferences.

Another aspect of this system can include a text input option, catering to users who prefer not to speak or are unable to use voice commands. This ensures accessibility and convenience for all users. Furthermore, the system can receive and analyze pictures provided by the user. By utilizing image recognition technology, the AI module can identify and report information such as historical significance, operating hours, and other relevant details about the objects or locations captured in the images. These expanded features enhance the versatility and usability of the system, providing a comprehensive and interactive user experience.

### BRIEF DESCRIPTION OF DRAWINGS

Various embodiments of the present disclosure are described below with reference to the following figures:

FIG. 1 shows an example mobile device;

FIG. 2 is a block diagram of an example system for the mobile device of FIG. 1;

FIG. 3 is a block diagram of an example implementation of the mobile device of FIG. 1;

FIG. 4 shows a flowchart of a method for generating an interactive tour guide according to an embodiment of the present disclosure; and

FIG. 5 shows a GUI of a mobile application for the interactive tour guide according to an embodiment of the present disclosure.

### DETAILED DESCRIPTION

The present disclosure relates to a mobile application that operates on a mobile device, such as a smartphone, to provide an interactive and personalized tour guide experience. Utilizing a combination of GPS) technology and advanced AI, the application accurately determines the user's geographical location and processes natural language queries about that location. By accessing a wide array of data sources, such as those accessible on the Internet or any other local or remotely store data, in real-time through the mobile device's communication interface, an AI module of the application synthesizes this information to generate context-aware, informative responses. These responses are then provided to the user via an intuitive user interface, e.g., video, audio, augmented reality, and other known interfaces, on the mobile device, thereby enhancing the travel experience by offering dynamic, tailored content based on the user's immediate surroundings and specific inquiries.

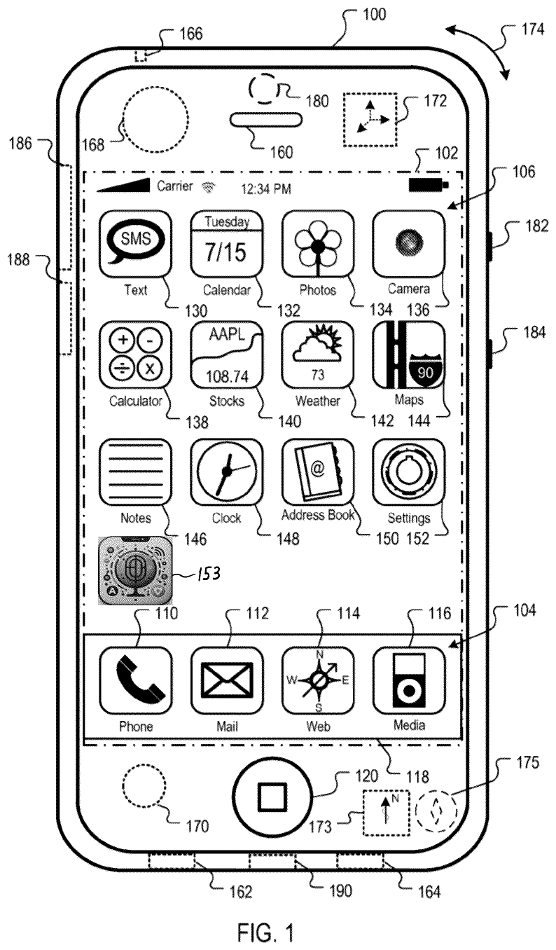

FIG. 1 shows an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, tablet, electronic book reader, virtual reality computing device, car display, and the like.

In some implementations, the mobile device 100 includes a touch-sensitive display 102. The touch-sensitive display 102 can implement liquid crystal display (LCD) technology, organic light emitting diode (OLED) technology, or any other suitable display technology. The touch-sensitive display 102 can be sensitive to haptic and/or tactile contact with a user.

In some implementations, the touch-sensitive display 102 can include a multi-touch-sensitive display 102. A multi-touch-sensitive display 102 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. In the example shown, the display objects 104, 106, are graphic representations of system objects. Some examples of system objects include device functions, applications, windows, files, alerts, events, or other identifiable system objects, which may be represented as icons, widgets, etc.

In some implementations, the mobile device 100 can implement multiple device functionalities, such as a telephony device, as indicated by a phone object 110; an e-mail device, as indicated by the e-mail object 112; a network data communication device, as indicated by the Web object 114; a Wi-Fi base station device (not shown); and a media processing device, as indicated by the media player object 116. In some implementations, particular display objects 104, e.g., the phone object 110, the e-mail object 112, the Web object 114, and the media player object 116, can be displayed in a menu bar 118. In some implementations, device functionalities can be accessed from a top-level graphical user interface, such as the graphical user interface illustrated in FIG. 1. Touching one of the objects 110, 112, 114 or 116 can, for example, invoke corresponding functionality.

In some implementations, upon invocation of device functionality, the graphical user interface of the mobile device 100 changes or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various e-mail functions; touching the Web object 114 may cause the graphical user interface to present display objects related to various Web-surfing functions; and touching the media player object 116 may cause the graphical user interface to present display objects related to various media processing functions.

In some implementations, the top-level graphical user interface environment or state of FIG. 1 can be restored by pressing a button 120 located near the bottom of the mobile device 100. The button 120 is exemplary and may be replaced by intuitive touch gestures. Users may return to the home page by swiping up from the bottom edge of the screen. Additionally, the mobile device 100 may incorporate gesture-based navigation that allows users to switch between applications, access applications, and return to the home screen with simple swipes and gestures. This shift towards a buttonless interface provides a seamless and more immersive user experience, aligning with the advancements in touch-sensitive display technology and user interface design.

In some implementations, each corresponding device functionality may have corresponding “home” display objects displayed on the touch-sensitive display 102, and the graphical user interface environment of FIG. 1 can be restored by pressing the “home” display object (not shown).

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a settings object 152. Touching the SMS display object 130 can, for example, invoke an SMS messaging environment and supporting functionality; likewise, each selection of a display object 132, 134, 136, 138, 140, 142, 144, 146, 148, 150 and 152 can invoke a corresponding object environment and functionality.

Additional and/or different display objects can also be displayed in the graphical user interface of FIG. 1. In some implementations, the display objects 106 can be configured by a user, e.g., a user may specify which display objects 106 are displayed, and/or may download additional applications or other software that provides other functionalities and corresponding display objects.

The mobile device 100 can include one or more input/output (I/O) devices and/or sensor devices. For example, a speaker 160 and a microphone 162 can be included to facilitate voice-enabled functionalities, such as phone and voice mail functions. In some implementations, a loudspeaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, one or more of an accelerometer 172, a compass 173, and a gyroscope 175 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the GPS or other positioning systems (e.g., systems using Wi-Fi access points, television signals, cellular grids, Uniform Resource Locators (URLs)). In some implementations, a positioning system (e.g., a GPS module) can be integrated into the mobile device 100 or provided as a separate device that can be coupled to the mobile device 100 through an interface (e.g., port device 190) to provide access to location-based services.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

In some implementations, a port device 190, e.g., a Universal Serial Bus (USB) port, or a docking port, or some other wired port connection, can be included. The port device 190 can, for example, be utilized to establish a wired connection to other computing devices, such as other communication devices 100, network access devices, a personal computer, a printer, or other processing devices capable of receiving and/or transmitting data. In some implementations, the port device 190 allows the mobile device 100 to synchronize with a host device using one or more protocols, such as, for example, the TCP/IP, HTTP, UDP and any other known protocol. In some implementations, a TCP/IP over USB protocol can be used.

### Network Operating Environment

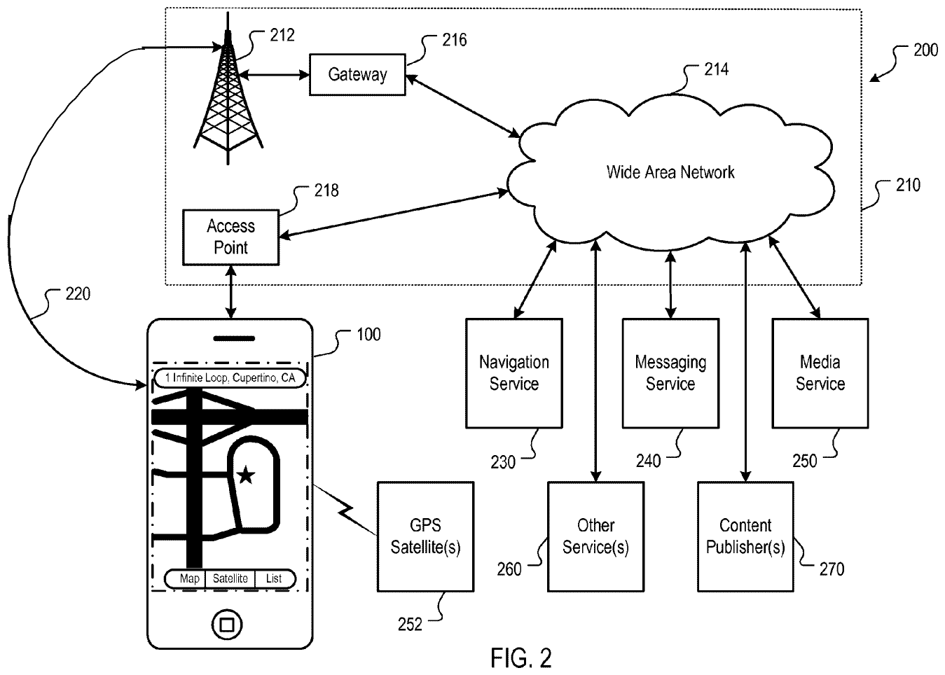

FIG. 2 is a block diagram of an example network operating environment 200 for the mobile device 100 of FIG. 1. The mobile device 100 of FIG. 1 can, for example, communicate over one or more wired and/or wireless networks 210 in data communication. For example, a wireless network 212, e.g., a cellular network, can communicate with a wide area network (WAN) 214, such as the Internet, by use of a gateway 216. Likewise, an access point 218, such as an 802.11g wireless access point, can provide communication access to the wide area network 214. In some implementations, both voice and data communications can be established over the wireless network 212 and the access point 218. For example, the mobile device 100 can place and receive phone calls (e.g., using VoIP protocols), send and receive e-mail messages (e.g., using POP3 protocol), and retrieve electronic documents and/or streams, such as web pages, photographs, and videos, over the wireless network 212, gateway 216, and wide area network 214 (e.g., using TCP/IP or UDP protocols). Likewise, the mobile device 100 can place and receive phone calls, send and receive e-mail messages, and retrieve electronic documents over the access point 218 and the wide area network 214. In some implementations, the mobile device 100 can be physically connected to the access point 218 using one or more cables and the access point 218 can be a personal computer. In this configuration, the mobile device 100 can be referred to as a “tethered” device.

The mobile device 100 can also establish communications by other means. For example, the wireless device 100 can communicate with other wireless devices, e.g., other wireless devices 100, cell phones, etc., over the wireless network 212. Likewise, the mobile device 100 can establish peer-to-peer communications 220, e.g., a personal area network, by use of one or more communication subsystems, such as the Bluetooth™ communication device 188 shown in FIG. 1. Other communication protocols and topologies can also be implemented.

The mobile device 100 can, for example, communicate with one or more services 230, 240, 250, and 260 and/or one or more content publishers 270 over the one or more wired and/or wireless networks 210. For example, a navigation service 230 can provide navigation information, e.g., map information, location information, route information, and other information, to the mobile device 100. In the example shown, a user of the mobile device 100 has invoked a map functionality, e.g., by pressing the maps object 144 on the top-level graphical user interface shown in FIG. 1, and has requested and received a map for the location “1 Infinite Loop, Cupertino, Calif.”

A messaging service 240 can, for example, provide e-mail and/or other messaging services. A media service 250 can, for example, provide access to media files, such as song files, movie files, video clips, and other media data. One or more other services 260 can also be utilized by the mobile device 100.

The mobile device 100 can also access other data and content over the one or more wired and/or wireless networks 210. For example, content publishers 270, such as news sites, RSS feeds, web sites, blogs, social networking sites, developer networks, etc., can be accessed by the mobile device 100. Such access can be provided by invocation of a web browsing function or application (e.g., a browser) in response to a user touching the Web object 114.

The mobile device 100 can also communicate with one or more GPS Satellite(s) 252 to enable circuitry and sensors (e.g., a GPS module on the mobile device 100) to support a location determining capability.

### Exemplary Mobile Device Architecture

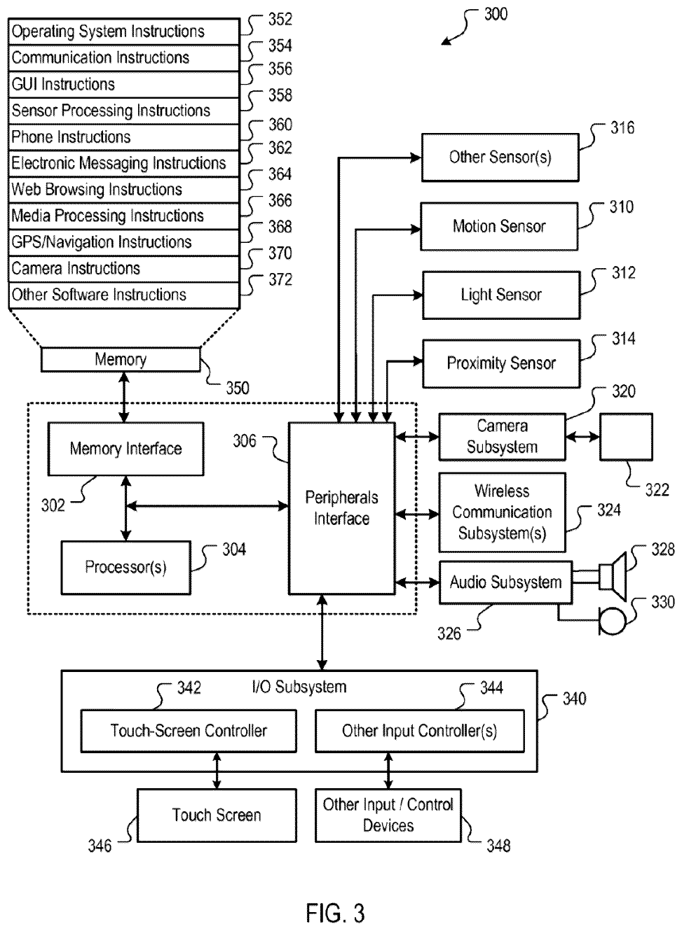

FIG. 3 is a block diagram 300 of an example implementation of the mobile device 100 of FIG. 1. The mobile device 100 can include a memory interface 302, one or more data processors, image processors and/or central processing units 304, and a peripherals interface 306. The memory interface 302, the one or more processors 304 and/or the peripherals interface 306 can be separate components or can be integrated in one or more integrated circuits. The various components in the mobile device 100 can be coupled by one or more communication buses or signal lines.

Sensors, devices and subsystems can be coupled to the peripherals interface 306 to facilitate multiple functionalities. For example, a motion sensor 310, a light sensor 312, and a proximity sensor 314 can be coupled to the peripherals interface 306 to facilitate the orientation, lighting and proximity functions described with respect to FIG. 1. Other sensors 316 can also be connected to the peripherals interface 306, such as a positioning system (e.g., GPS module), a temperature sensor, a biometric sensor, or other sensing device, to facilitate related functionalities.

A camera subsystem 320 and an optical sensor 322, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device 100 is intended to operate. For example, a mobile device 100 may include communication subsystems 324 designed to operate over a GSM network, a GPRS network, an EDGE network, a Wi-Fi or WiMax network, and a Bluetooth™ network. In particular, the wireless communication subsystems 324 may include hosting protocols such that the device 100 may be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346.

The other input controller(s) 344 can be coupled to other input/control devices 348, such as one or more buttons, rocker switches, thumbwheel, infrared port, USB port, and/or a pointer device such as a stylus. The one or more buttons (not shown) can include an up/down button for volume control of the speaker 328 and/or the microphone 330.

In one implementation, a pressing of the button for a first duration may disengage a lock of the touch screen 346; and a pressing of the button for a second duration that is longer than the first duration may turn power to the mobile device 100 on or off. The user may be able to customize a functionality of one or more of the buttons. The touch screen 346 can, for example, also be used to implement virtual or soft buttons and/or a keyboard. As noted above, users may return to the home page by swiping up from the bottom edge of the screen. Additionally, the mobile device 100 may incorporate gesture-based navigation that allows users to switch between applications, access applications, and return to the home screen with simple swipes and gestures. This shift towards a buttonless interface provides a seamless and more immersive user experience, aligning with the advancements in touch-sensitive display technology and user interface design.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 36-pin connector that is compatible with the iPod. Other input/output and control devices can also be used.

The memory interface 302 can be coupled to memory 350. The memory 350 can include high-speed random access memory and/or non-volatile memory, such as one or more magnetic disk storage devices, one or more optical storage devices, and/or flash memory (e.g., NAND, NOR). The memory 350 can store an operating system 352, such as Darwin, RTXC, LINUX, UNIX, OS X, WINDOWS, or an embedded operating system such as VxWorks. The operating system 352 may include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 may include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; and/or other software instructions 372 to facilitate other processes and functions.

Each of the above identified instructions and applications can correspond to a set of instructions for performing one or more functions described above. These instructions need not be implemented as separate software programs, procedures or modules. The memory 350 can include additional instructions or fewer instructions. Furthermore, various functions of the mobile device 100 may be implemented in hardware and/or in software, including in one or more signal processing and/or application specific integrated circuits.

In an implementation, the mobile device 100 includes an integrated GPS module. Alternatively, or in addition, the mobile device 100 can accept a GPS module as an accessory. Communication with an accessory GPS module can occur via a wired connection such as a USB connection, a secure digital interface, or other wired connection types. Communication can also occur via a wireless connection such as IEEE 802.x, Bluetooth™, or other wireless communication formats. The location of the mobile device can be measured using information received from orbiting GPS satellites using the GPS module. The present latitude and longitude of the mobile device can be determined and shown on the display 102 with a map of the surrounding area. For example, selection of the map object 144 can present a user with a map showing the user's current location and a menu of options for manipulating the map using navigation features of the device 100. Other positioning systems (e.g., systems using Wi-Fi access points, television signals, cellular grids, etc.) can also be used.

In an implementation, past locations of the device 100 are stored in memory 350 so that a location history or a traveled path can be displayed. These past routes can be bookmarked or otherwise categorized for easy recall by the user.

As described above, environmental factors can prevent the location of the device being determined. For example, GPS reception is often not possible unless a line of sight can be established between the GPS module and the number of satellites needed to compute the receiver's location. Likewise, other location systems can also experience reception degradation, e.g., radio frequency interference or multiple time delayed versions of a transmission received due to reflections off of surrounding structures.

In an implementation, the device 100 includes one or more of an accelerometer 172, a magnetic compass 173, and/or a gyroscope 175. The accelerometer 172, compass 173, and/or gyroscope 175 can be used alone or in combination to measure movements of the device 100. Additional sensors can be located external to the device 100 on the person of the user. For example, any, some, or all of an accelerometer, a compass, a gyroscope, and an impact sensor can be located on or in the user's footwear. An impact sensor detects footwear contact with the ground, facilitating the measurement of a number of steps. A distance traveled can be estimated using the product of the average length of a user's stride and a number of steps taken. Alternatively contact with the ground during walking can be measured using an accelerometer that detects the change in velocity of a shoe as it contacts the ground. The sensors can be located on or in one or both of the user's shoes. The external sensors can send information to the device 100 via a wireless link. The length of the user's stride can be set and stored in device memory.

Sensor data from accelerometers, a compass, gyroscopes, and impact sensors can be used alone or in combination to, for example, measure the movement of the device 100 from a point of origin or known location (a “fix”) to determine the device's location relative to the fix. Location measurement techniques of this type are generally referred to as “dead reckoning.” Dead reckoning can be used in conjunction with other location measurement techniques such as GPS or user input, and used in cases where no satellite or terrestrial positioning signal information is available (whether the unavailability is due to interference in the operating environment or the lack or reception capabilities in the device). In an implementation, the device 100 is configured to switch into a dead reckoning positioning mode upon another positioning mode becoming unavailable.

The present disclosure provides a mobile application that integrates advanced AI with GPS technology to deliver a dynamic and interactive tour guide experience.

With reference to FIG. 1, the mobile device 100 includes a tour guide application shown as a tour guide object 153. The tour guide application functions as an intelligent, real-time tour guide by leveraging advanced AI, integrated GPS functionality, and internet data access to answer user queries about their surroundings and generate personalized and interactive tour guides.

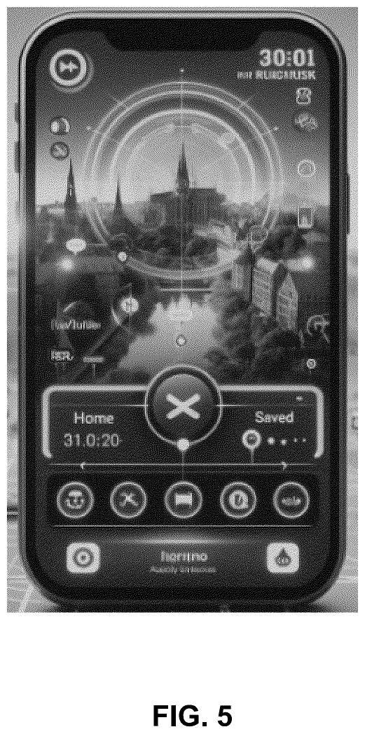

The application is shown in FIG. 5 and includes a user interface component having an input interface and an output interface. The input interface allows the user to interact by touching GUI elements on the touch-sensitive display 102, providing voice commands via the microphone 162, and/or text inputs to ask questions and provide requests to the tour guide application. User requests are processed using an AI module, which is a software system equipped to manage tasks requiring AI. The AI module incorporates a variety of algorithms and models trained to analyze vast amounts of data, recognize patterns, and execute functions that mimic human cognitive abilities. Key functionalities of an AI module include machine learning models for specific tasks like image and speech recognition, NLP for understanding and generating human language, data processing units for handling data efficiently, and decision modules that use insights from data to make informed choices or recommendations.

The execution of an AI module can vary based on the application's demands, the complexity of tasks, and required computational resources. In some instances, AI module is executed directly on the mobile device 100. This local deployment is typical in applications where immediate response times are critical and maintaining user privacy is paramount, such as in voice-assisted devices or AI-enhanced smartphone cameras. In some implementations, for more complex AI tasks that require substantial computational power, the AI module may be executed on cloud-based servers using one of the services 260 (illustrated in FIG. 2). This allows for robust processing capabilities, scalability, and streamlined updates and maintenance of AI models. Such setups are prevalent in applications involving extensive AI-driven analytics or comprehensive NLP tasks like those performed by AI chatbots. Additionally, a hybrid approach may be used, where initial processing is managed locally, and more resource-intensive processing is handled in the cloud. This method optimally balances performance and resource utilization. Another approach involves edge computing, particularly beneficial in scenarios requiring high data privacy or in environments with unreliable internet connectivity.

The output interface of the tour guide application provides output in response to the user requests on the display 102 and/or audio. As shown in FIG. 5, visual display may include videos, images, text, maps, directions, augmented reality overlays, and the like. [Should there be a figure illustrating an implementation of this? Perhaps a figure illustrating a text output (i.e. closed captioning or responding to a text input) would be helpful as well]

The application also connects to an internet data retrieval system designed to gather the most recent and relevant information from a variety of online sources, including databases, news websites, and specialized content repositories (e.g., content publishers 270 illustrated in FIG. 2). The mobile application may use web scraping, API calls, and access to curated data pools to provide comprehensive and up-to-date information.

Additionally, the application leverages GPS technology to provide location-specific services. The tour guide application receives GPS data from GPS satellites 252 to pinpoint the user's exact location. This geographical information is used to provide context-specific answers and suggestions. Based on the location data, the app can suggest nearby points of interest, routes, and even create custom tour paths based on user preferences (e.g., historical sites, nature trails). By determining the user's precise location, the application can tailor responses and route-based data, including directions and points of interest specific to the user's geographical context. The AI module then synthesizes the collected data into coherent responses, which are presented to the user through the display or audio output of the mobile device 100. In one embodiment, the responses are live, unrecorded, dynamic, and on-the-fly voice responses. In another embodiment, the responses are live, unrecorded, dynamic, and on-the-fly text responses. In still another embodiment, the responses are live, unrecorded, dynamic, and on-the-fly image responses.

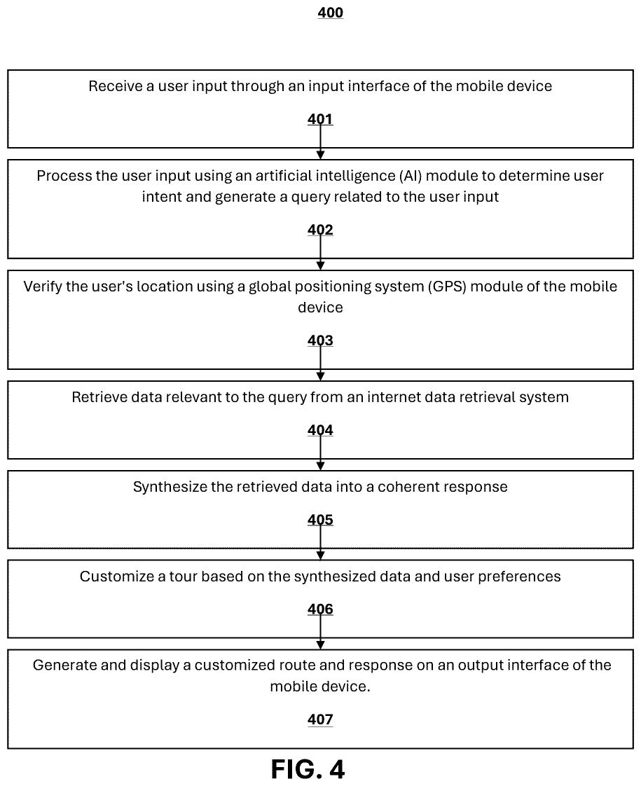

FIG. 4 shows a flowchart of a method 400 for generating an interactive tour guide. Step 401—User Input Reception: The user activates the application and in one embodiment, uses the voice recognition feature to ask for a tour, e.g., of historical sites in Washington, D.C, or any other desired information. The voice recognition module captures this spoken request and converts it into text. In another embodiment, the user activates the application and uses a text feature to ask for a tour or location/historic information.

Step 402—Query Processing: The converted text is sent to the AI and NLP module. This module analyzes the text to understand the user's intent and the specific request, e.g., for historical sites in Washington, D.C.

Step 403—Location Verification: The GPS module confirms the user's current location to ensure that the provided information is relevant to their actual or intended position. If the user is already in at the location, e.g., Washington, D.C., the application proceeds with location-specific data.

Step 404—Data Retrieval: Based on the processed query, the AI module formulates specific internet queries to fetch information about the requested location. The internet data retrieval system accesses various online resources to gather current and comprehensive data about these sites.

Step 405—Data Synthesis: The AI module compiles and synthesizes the retrieved data into an organized format. It creates a list of historical sites, including descriptions, historical significance, visitor information, and current events or exhibitions. Additionally, the AI module can compile and synthesize data on a wide variety of topics beyond historical sites. This includes information on entertainment options such as theaters, concerts, and festivals; famous historical markers; general points of interest like parks and landmarks; as well as other user-specific queries. This comprehensive approach ensures that the user receives a broad spectrum of relevant information tailored to their interests and location.

Step 406—Tour Customization: The application assesses the user's preferences (if previously set) or prompts the user to select specific types of sites they are most interested in (e.g., museums, war memorials, government buildings, universities, types of restaurants, national forests, genre interests (i.e. movies, historical preferences), and other general interests/hobbies such as movies, bird-watching, types of art, etc.). Based on this input, the AI module customizes the tour to focus on the user's interests.

Step 407—Route Generation: Utilizing the GPS data, the application generates an optimal route that the user can follow to visit the selected historical sites. The route is designed to minimize travel time and ensure a logical sequence of visits based on geographical proximity and opening hours of the sites. The synthesized information and customized route are compiled into a user-friendly format and presented to the user via the mobile application's interface. The user can view details on the map, read brief descriptions, and get directions for each site on the tour. As the user proceeds with the tour, they can ask follow-up questions or request additional information about each site through the voice interface. The AI module continues to provide real-time information and answers, enhancing the interactive experience of the tour thus reverting back to Step 401. After completing the tour, the user may be prompted to provide feedback on their experience. This feedback is used to refine the AI algorithms and improve future tour customizations and recommendations.

This method demonstrates a comprehensive approach to handling user requests, utilizing advanced technologies like AI, NLP, GPS, and real-time data retrieval to deliver a personalized and interactive tour experience directly through a smartphone application.

The present disclosure thus offers a unique combination of GPS precision and AI-driven content synthesis, enabling a personalized and engaging travel guide experience. This detailed description along with the referenced figures provides a comprehensive understanding of the disclosure's structure and functionality.

Alternate embodiments may be devised without departing from the spirit or the scope of the present technology. Additionally, well-known elements of embodiments of the systems, apparatuses, and methods have not been described in detail or have been omitted so as not to obscure the relevant details of the systems, apparatuses, and methods.

The terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

When the terms “coupled” and “connected,” along with their derivatives, are used, these terms are not intended as synonyms for each other. For example, “connected” may be used to indicate that two or more elements are in direct physical or electrical contact with each other. “Coupled” may mean that two or more elements are in direct physical or electrical contact (e.g., directly coupled) or that two or more elements are not in direct contact with each other but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in tum, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Various embodiments of the systems, apparatuses, and methods have been described, and in many of the different embodiments many features are similar. To avoid redundancy, repetitive description of these similar features may not be made in some circumstances. It shall be understood, however, that description of a first-appearing feature applies to the later described similar feature and each respective description, therefore, is to be incorporated therein without such repetition.

From the foregoing, it will be appreciated that specific embodiments of the disclosure have been described herein for purposes of illustration, but that various modifications may be made without deviating from the scope of the disclosure. Accordingly, the disclosure is not limited except as by the appended claims.

What is claimed is:

1. A mobile application system comprising:
a processor configured to execute software instructions;
a memory coupled to the processor for storing software instructions;
a global positioning system (GPS) module to determine a geographical location of a user;
a communication interface for accessing a wide area network;
an artificial intelligence (AI) module configured to process natural language query received from the user requesting a tour guide pertaining to the geographical location of the user and to synthesize information relevant to the geographical location of the user from multiple internet sources; and
an output module configured to present the synthesized information to the user in an interactive manner.

2. The system of claim 1, wherein the AI module is further configured to understand and respond to follow-up questions from the user, maintaining context from previous interactions.

3. The system of claim 1, wherein the AI module includes a large language model.

4. The system of claim 1, wherein the GPS module provides real-time location tracking to dynamically update the information as the geographical location of the user changes.

5. The system of claim 1, wherein the output module includes a graphical user interface (GUI) on a mobile device that displays the synthesized information visually along with auditory responses.

6. The system of claim 1, further comprising a voice recognition module configured to receive the query from the user and to convert these into text for processing by the AI module.

7. The system of claim 1, wherein the communication interface is configured to retrieve information from at least databases, web pages, and multimedia sources.

8. The system of claim 1, further configured to allow the user to specify preferences for types of information or topics, which the AI module uses to filter and prioritize the information provided to the user.

9. A method for providing an interactive tour guide using a mobile device, comprising:
receiving a user input through an input interface of the mobile device;
processing the user input using an artificial intelligence (AI) module to determine user intent and generate a query related to the user input;
verifying a user's location using a global positioning system (GPS) module of the mobile device;
retrieving data relevant to the query from an internet data retrieval system;
synthesizing the retrieved data into a coherent response;
customizing a tour based on the synthesized data, user preferences, and the user's location; and
generating and displaying a customized route and response on an output interface of the mobile device.

10. The method of claim 9, wherein receiving the user input includes capturing voice commands via a microphone, converting the voice commands to text, and processing the text as the user input.

11. The method of claim 9, wherein the AI module utilizes natural language processing (NLP) to analyze and interpret the user input.

12. The method of claim 9, wherein the data retrieval includes accessing multiple online sources such as databases, news websites, and specialized content repositories to gather current information relevant to the user's query.

13. The method of claim 9, wherein customizing the tour involves selecting points of interest based on the user's location and preferences.
